(19) United States
(12) Patent Application Publication
(10) Pub. No.: US 2005/0213334 A1
(43) Pub. Date: Sep. 29, 2005

(54) Ceramic packaging for high brightness LED devices

(76) Inventors: Kong Weng Lee, Penang (MY); Kee Yean Ng, Penang (MY); Meng Ee Lee, Penang (MY); Kian Shin Lee, Penang (MY); Janet Bee Yin Chua, Penang (MY)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/812,526

(22) Filed: Mar. 29, 2004

(51) Int. Cl. F21V 7/00

(52) U.S. Cl. 362/310; 362/84; 362/800

(57) ABSTRACT

Embodiments of the present invention include a light emitting diode package comprising a ceramic cavity comprising a substrate for mounting a light emitting diode and substantially vertical sidewalls for reducing light leakage. The ceramic LED package further includes a metallic coating on a portion of the ceramic substrate for reflecting light in a predetermined direction.

### TECHNICAL FIELD

The present invention relates to packaging technologies. More specifically, the present invention relates to packaging for light emitting diodes (LEDs).

### BACKGROUND ART

Light emission diode packages (“LED packages”) are semiconductor devices, which have LED chips acting as light sources. LEDs comprise compound semiconductor materials that produce light when electrically activated. Some examples of some compound semiconductor materials are GaAs, AlGaAs, GaN, InGaN and AlGaInP,

As an LED converts electric energy into light, it is highly efficient and far more durable, and consumes much less electricity than filament bulbs. As the practical use of LEDs gains momentum, they are becoming more widely used in displays such as the indicators for electrical appliances and the backlights for liquid crystal displays in cellular phones.

Conventional LED packages are made of plastic to keep component size and cost down. The plastic shell houses one or more LEDs and is then filled with an optically transparent material to seal and protect the LED from the environment.

One problem associated with conventional plastic LED packages is light leakage. To help make smaller LED packages, the thickness of the plastic package is reduced. As a result, the thinner packaging of the LED allows light leakage through the LED package. Light leakage makes the LED device less efficient, thus requiring more power to achieve a desired brightness, resulting in more power consumption of the device it is in. In addition, as electronic devices become smaller, LEDs must also be smaller. As a result, the smaller LED package has problems with dissipating the heat that is generated by high brightness LEDs.

### SUMMARY OF THE INVENTION

Embodiments of the present invention include a light emitting diode package comprising a ceramic cavity comprising a substrate for mounting a light emitting diode and substantially vertical sidewalls for reducing light leakage. In one embodiment, the opaque nature of the ceramic material and specifically the reflective plating that prevent light leakage. The ceramic LED package further includes a metallic coating on a portion of the ceramic substrate for reflecting light in a predetermined direction.

Embodiments of the invention also include a method for manufacture of a light emitting diode package comprising forming a ceramic cavity comprising a substrate for mounting a light emitting diode and substantially vertical sidewalls for reducing light leakage. The method further includes coating a portion of the ceramic cavity with a light reflective material, positioning a light emitting diode on the substrate and depositing an optically transparent material in the cavity to protect the light emitting diode.

Additional embodiments of the present invention include forming a one-piece substrate and cup LED package and forming the cup in different shapes to focus light in a predetermined direction. In other embodiments of the present invention, the vertical placement of an LED device in the cavity is adjusted to widen and narrow the viewing angle of the LED device. Furthermore, molded epoxy is deposited over the LED package in multiple arrangements to further direct the direction of light.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a side view illustration of an exemplary ceramic LED package comprising an light reflective coating in accordance with embodiments of the present invention.

FIGS. 2A-2D are side view illustrations of an exemplary ceramic LED package during several processing steps in accordance with embodiments of the present invention.

FIG. 3 is flow diagram of an exemplary process for manufacturing a ceramic LED package in accordance with embodiments of the present invention.

FIG. 4 is a top and bottom view of an exemplary ceramic LED package in accordance with embodiments of the present invention.

FIG. 5A is an illustration of an exemplary one-piece ceramic light emitting diode substrate with an oval reflector cup in accordance with embodiments of the present invention.

FIG. 5B is an illustration of an exemplary one-piece ceramic light emitting diode substrate with a trapezoidal reflector cup in accordance with embodiments of the present invention.

FIG. 5C is an illustration of an exemplary one-piece ceramic light emitting diode substrate with a circular reflector cup in accordance with embodiments of the present invention.

FIG. 5D is an illustration of an exemplary one-piece ceramic light emitting diode substrate with a square reflector cup in accordance with embodiments of the present invention.

FIG. 6A is an illustration of an exemplary one-piece ceramic substrate and reflector cup with a LED at an adjustable height in accordance with embodiments of the present invention.

FIG. 6B is an illustration of an exemplary one-piece substrate and reflector cup with molded epoxy in a domed shape in accordance with embodiments of the present invention.

FIG. 6C is an illustration of an exemplary one-piece substrate and reflector cup with molded epoxy in a concave shape in accordance with embodiments of the present invention.

### DETAILED DESCRIPTION OF THE INVENTION

Reference will now be made in detail to the various embodiments of the invention, examples of which are illustrated in the accompanying drawings. While the invention will be described in conjunction with the various embodiments, it will be understood that they are not intended to limit the invention to these embodiments. On the contrary, the invention is intended to cover alternatives, modifications and equivalents, which may be included within the invention as defined by the appended claims.

Furthermore, in the following detailed description of the invention, numerous specific details are set forth in order to provide a thorough understanding of the invention. However, it will be obvious to one skilled in the art that the invention may be practiced without these specific details. In other instances, well-known methods, procedures, components, and circuits have not been described in detail as not to unnecessarily obscure aspects of the invention.

The present invention relates to the manufacture of a ceramic LED package. The exemplary ceramic LED package of the present invention has excellent thermal properties and endurance to withstand heat from a high brightness LED device contrary to conventional plastic LED packages. The thermal properties of the ceramic package allow improvement in the brightness of LEDs without the requirement of making the package resistant to additional heat produced and without equipping the package with means for dissipating the heat quickly. The use of alumina and or aluminum nitride ceramic materials makes the ceramic LED package less susceptible to the degrading heat generated by high brightness LED devices. In addition, the ceramic package retains more light and does not allow light leakage as do conventional resin based LED packages. Such ceramic package also allows the use of high temperature during the assembly processes.

Ceramic LED packages can be made in smaller dimensions than conventional resin based LED packages and manufacturing techniques allow the sidewalls of the ceramic LED package to be formed substantially vertical, thus increasing the surface area of the ceramic cavity and allowing multiple LED devices to be mounted in a single ceramic LED package. The use of ceramic provides a more electrically efficient LED device that can be made smaller and at a lower cost.

Embodiments of the present invention are related to packaging for high brightness LED devices. In one embodiment of the invention, a ceramic substrate is used to reduce light leakage in a high brightness LED to improve efficiency of the LED. Reducing the amount of light leakage reduces the amount of power required to achieve a desired brightness. In addition to a ceramic package substrate, embodiments of the present invention provide a ceramic LED package that is coated with a light reflective material to further increase light intensity and to further reduce light leakage.

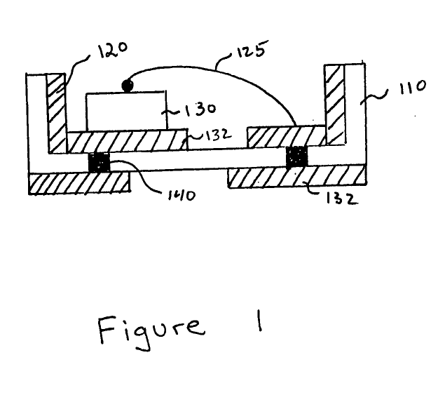

FIG. 1 is an illustration of an exemplary ceramic light emitting diode package in accordance with embodiments of the present invent. Ceramic package 100 comprises a ceramic substrate 110 with substantially vertical sidewalls. In accordance with embodiments of the present invention, the ceramic package 110 contains and focuses light more effectively than a conventional package made from plastic. In one embodiment of the invention, the ceramic package is coated with a light reflective material to further improve efficiency of the LED by reflecting light in a predetermined direction. By reflecting light in a particular direction, less power is needed to produce a desired brightness in a particular direction. In a conventional LED package, light leaks through the sidewalls and therefore require more power to achieve a desired brightness.

In one embodiment of the present invention, ceramic package 100 comprises electrical connections 140 to electrically couple LED 130 to a first portion of metal routing 132 on the inside of the ceramic package and the outside of the ceramic package. In addition, a wire bond 125 can be used to electrically couple LED 130 to a second portion of metal routing 132.

The present invention provides a ceramic LED packaging to reduce light leakage of a high brightness LED. In addition to reducing light leakage, a ceramic package allows the dimensions of the package to be scaled down. In accordance with embodiments of the present invention, a ceramic LED package can be made in smaller dimensions than a conventional plastic LED package. In addition, the contour of the sidewalls of the ceramic package can be manufactured such that the sidewalls are substantially vertical. In a conventional LED package, the sidewalls are not vertical (e.g., slopping from the top of the package to the bottom of the package) because the manufacture of plastic LED packages produces sidewalls that are not vertical, thus reducing the area on the bottom of the package. In one embodiment of the present invention, the ceramic LED package comprises vertical sidewalls, thus increasing the surface area of the bottom of the package given a particular device dimension.

In one embodiment of the present invention, the ceramic LED package 110 is plated with metal to form a light reflective coating on the inner surface of the ceramic package 110. In one embodiment of the invention, the metallic plating is silver, but the plating can be any light reflective material that can be deposited on the surface of the ceramic package 110. In one embodiment of the invention, silver is electro plated on the surface of the ceramic package. It is appreciated that any process well known can be used to coat the ceramic package 110 with the light reflective material 120.

In one embodiment of the invention, the light reflective material is formed in specific locations to reflect light in a predetermined direction. As such, these locations may not be electrically connected to the metal routing 132.

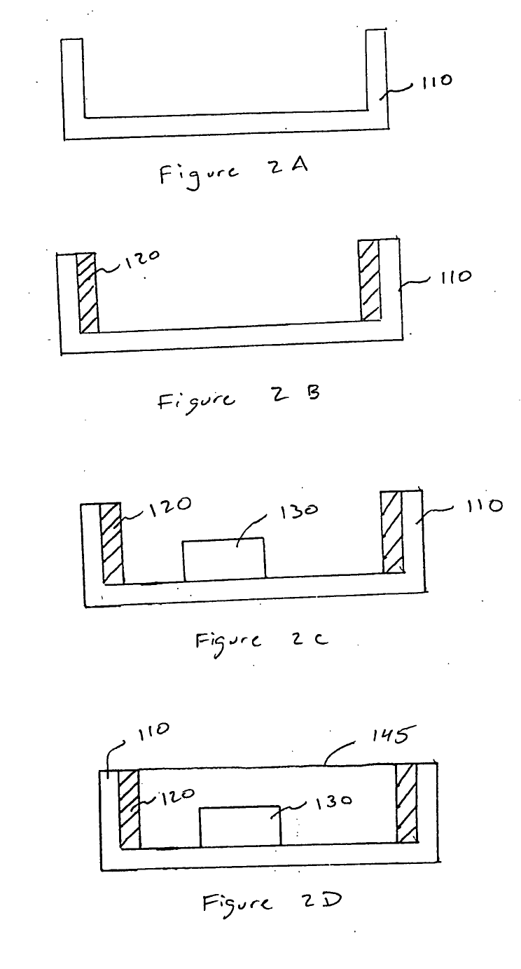

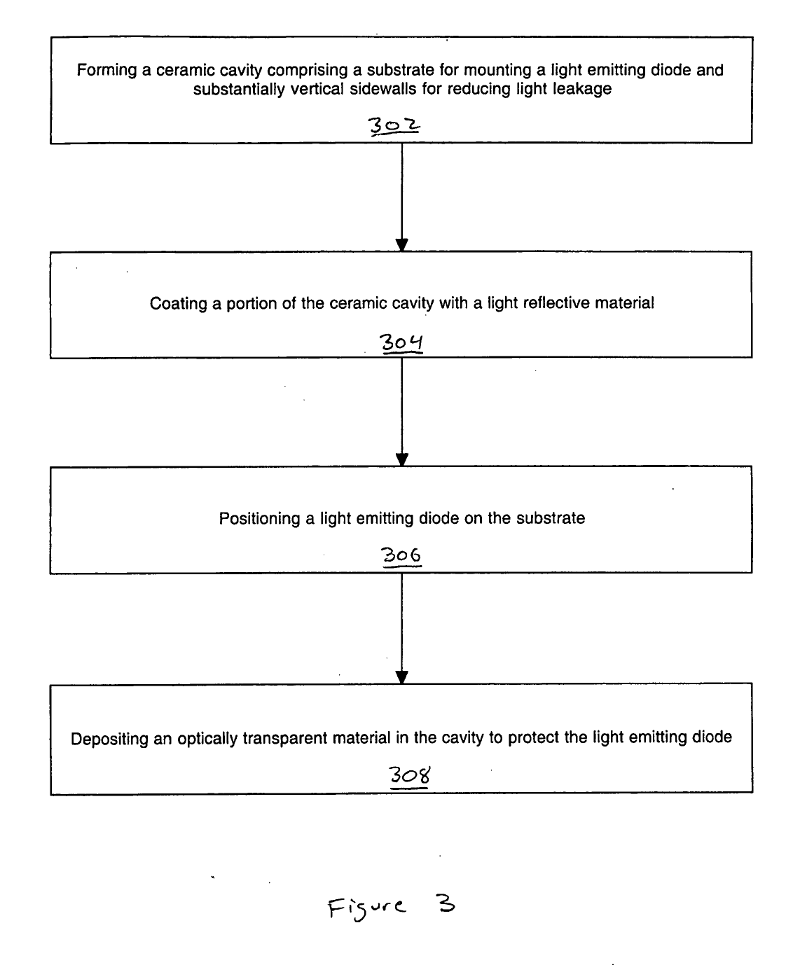

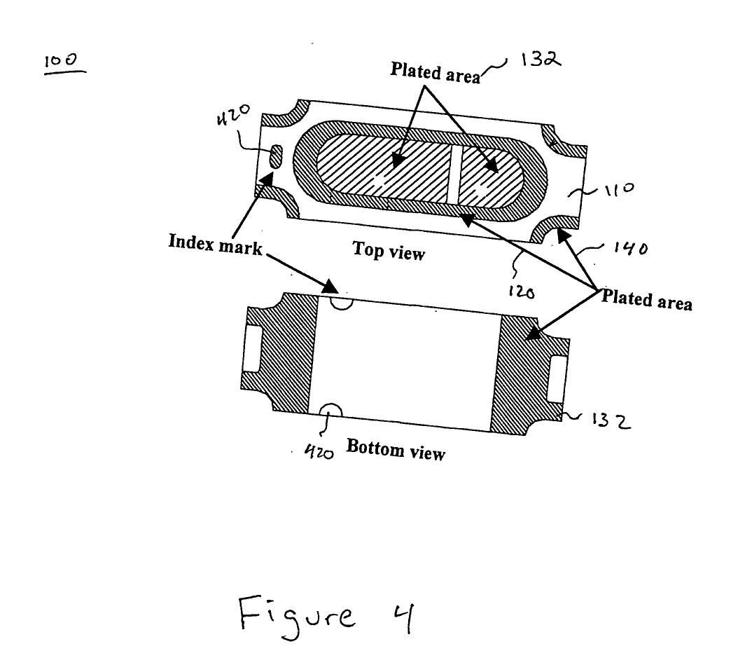

FIGS. 2A-2D are illustrations of an exemplary ceramic LED package during different processing steps in accordance with embodiments of the present invention. For clarity, exemplary process 300 of FIG. 3 will be described in conjunction with FIGS. 2A-2D.

FIG. 2A is a side view illustration of an exemplary ceramic LED package 110 in accordance with embodiments of the present invention. In one embodiment of the invention, the ceramic material used to form the ceramic package 110 is an alumina or aluminum nitride based ceramic material. Alumina and aluminum nitride based ceramics tolerate extreme heat and offers more efficient heat dissipation qualities than conventional plastic or resin based materials, thereby providing a greater degree of brightness of the LED device. It is appreciated that the ceramic material can be any ceramic material suitable for use with a high brightness LED device. In one embodiment of the invention, the ceramic material used to form the ceramic package 110 comprises physical properties that facilitate electroplating of metallic materials to the ceramic surface.

In one embodiment of the invention, multiple ceramic packages 110 are formed in sheets wherein multiple ceramic packages are formed at once. In one embodiment, the ceramic packages are formed using a die that can be stamped on a sheet of ceramic material to form the ceramic LED package 110. In accordance with the present invention, the sidewalls of the ceramic package 110 are substantially vertical, thus providing maximum surface area on the bottom of the ceramic package 110 for mounting multiple LED devices. By using ceramic material to form the package 110, the dimensions of the package can be smaller than conventional LED packages, thus reducing the footprint of a device that achieves a desired brightness level. Step 302 of FIG. 3 is forming a ceramic cavity comprising a substrate for mounting a light emitting diode and substantially vertical sidewalls for reducing light leakage. Many different methods for forming the ceramic package 110 can be used and the methods for forming small ceramic packages are well known in the art.

FIG. 2B is a side view illustration of an exemplary ceramic LED package coated with a light reflective material in accordance with embodiments of the present invention. After the ceramic package 110 is formed, step 304 of exemplary process 300 of FIG. 3 is coating a portion of the ceramic cavity with a light reflective material. FIG. 2B illustrates light reflective coating 120 on portions of the ceramic package 110 in accordance with embodiments of the present invention. In one embodiment of the invention, the light reflective coating is silver metal. It is appreciated that the light reflective coating can be any light reflective material that can be coated on portions of the ceramic package 110.

In one preferred embodiment of the present invention, the light reflective coating is metallic and is electro plated on the ceramic LED package 110. In one embodiment of the invention, the light reflective coating 120 is an opaque metallic coating. The light reflective coating increases the total light intensity and flux the LED. In addition, the light from the LED can be focused in a predetermined location thus further increasing the efficiency of the device in a specific direction.

FIG. 2C is a side view illustration of an exemplary ceramic package with a light reflective coating and an LED device in accordance with embodiments of the present invention. Step 306 of exemplary process 300 of FIG. 3 is to position a light emitting diode on the ceramic substrate of the ceramic package in accordance with embodiments of the present invention. FIG. 2C illustrates a LED 130 positioned on the bottom surface of the ceramic LED package 110. After the light reflective coating 120 is formed on the vertical sidewalls of the ceramic package 110, the LED can be positioned on the substrate. In one embodiment of the invention, multiple LED devices are positioned in a single ceramic LED package. As a result of the vertical sidewalls of the ceramic package 110, sufficient area on the substrate surface is available to position multiple LED devices.

As illustrated in FIG. 1, multiple electrical connectors 140 are located in ceramic package 110 to electrically couple LED 130 to an outside power source. The electrical connectors 140 are not illustrated in FIGS. 2A-2D for clarity, but it is appreciated that in one embodiment of the invention, electrical connectors are located in the ceramic package 110 to electrically couple LED 130 to a power source. A metal routing 132 may also be provided for this purpose. FIG. 2C illustrates the reflective coating 120 on the sidewalls of the ceramic package 110. In one embodiment of the invention, the reflective coating is formed in specific locations on the ceramic package to focus light in a predetermined location. For example, the light reflective coating may be formed on the bottom surface of the ceramic package 110.

After the LED is positioned in the ceramic LED package, the next step of exemplary process 300 of FIG. 3 is step 308 which includes depositing an optically transparent material 145 in the cavity the ceramic LED package 110 to protect the LED 130. In one embodiment of the present invention, the optically transparent material 145 is epoxy. The optically transparent material 145 protects the LED device 130 from environmental factors such as vibration, water and dust contamination. The optical properties of the material allow light emitted from the LED device to pass through the material without substantial loss of brightness. Other optically transparent materials such as silicone and glass can also be used.

FIG. 4 illustrates a top view and a bottom view of an exemplary ceramic LED package 100 in accordance with embodiments of the present invention. LED package 100 comprises a ceramic package 110 comprising a cavity that comprises a plated area 120 for reflecting light from an LED in a predetermined direction. In addition, exemplary LED package 100 comprises electrical connectors 140 for electrically coupling an LED device (not shown for clarity) to a power source. In one embodiment of the invention, the ceramic package 110 is rectangular shaped with an oval shaped cavity in the middle of the package. The oval cavity has substantially vertical sidewalls that are plated with a light reflective coating 120 to direct light from an LED in a predetermined direction to improve the brightness and efficiency of the LED, thus decreasing the required power to achieve a desired brightness. To aid in manufacturing, index marks 420 are provided to aid in positioning in various steps of the manufacture process. On the bottom view, the plated area 132 is used to rout electrical power to the LED device. In one embodiment of the invention, the LED package 100 is a surface mountable device.

Additional embodiments of the present invention include a one-piece ceramic package comprising a substrate and an embedded reflector cup in accordance with embodiments of the present invention. In one embodiment of the invention, the shape of the reflector cup is modified to focus light in a desired location. In other embodiments of the present invention, a reflective material, such as silver or gold, can be disposed on the walls of the reflector cup to further enhance the brightness of the device. Furthermore, epoxy resin can be deposited in the reflector cup and over the LED to protect the LED. In one embodiment of the invention, the epoxy is formed in a dome or concave over the LED to further control the viewing angle of the LED device. Additionally, the vertical location of the LED device, with respect to the bottom and top of the reflector cup, can be modified to change the viewing angle of the device.

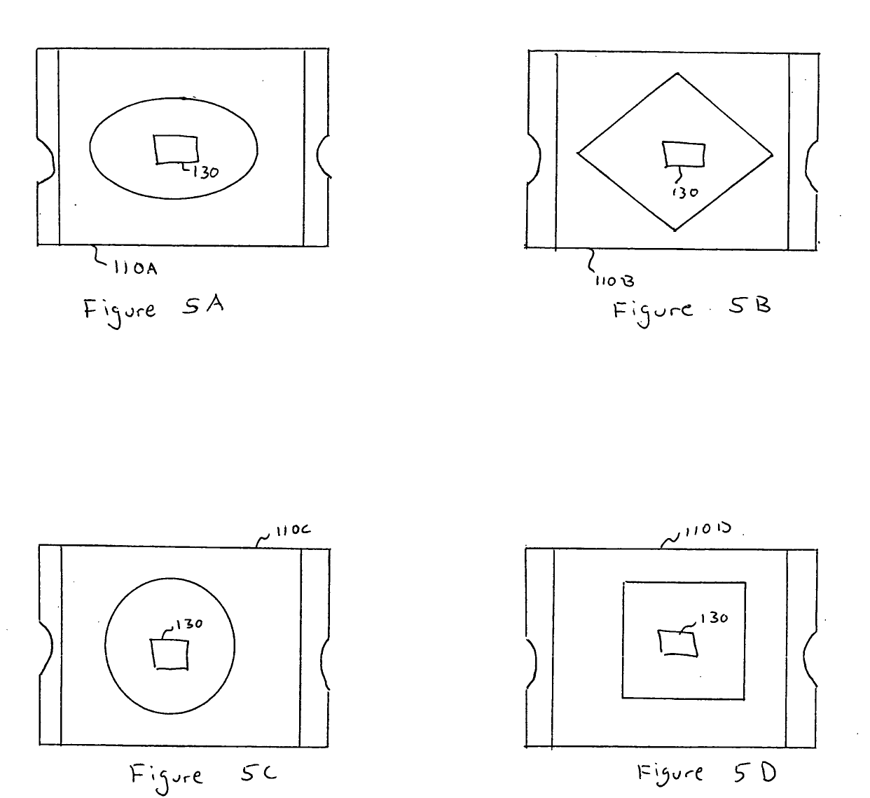

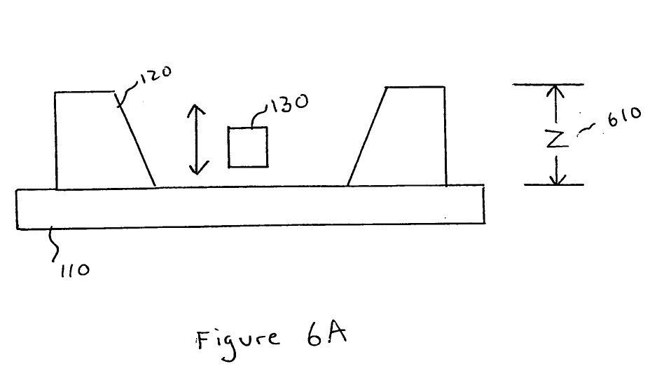

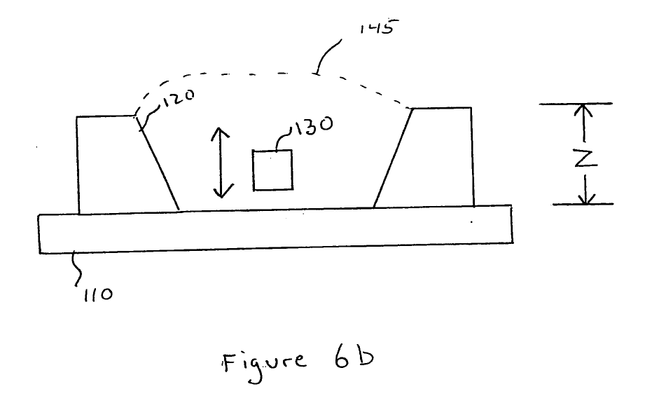

FIG. 5A is an illustration of an exemplary one-piece ceramic light emitting diode substrate with an oval reflector cup in accordance with embodiments of the present invention. In this embodiment of the invention, the LED 130 is located in an oval shaped reflector cup of the LED substrate 110a. The oval shaped reflector cup can be used to reflect light in a predetermined location. In one embodiment of the invention, the LED substrate 110a is made of ceramic and is a one-piece substrate and reflector cup.

FIG. 5B is an illustration of an exemplary one-piece ceramic light emitting diode substrate with a trapezoidal reflector cup in accordance with embodiments of the present invention. In this embodiment of the invention, the LED device 130 is located in a trapezoidal shaped reflector cup of the LED substrate 110b. The trapezoidal shaped reflector cup can be used to reflect light in a predetermined location. In one embodiment of the invention, the LED substrate 110b is made of ceramic and is a one-piece substrate and reflector cup.

FIG. 5C is an illustration of an exemplary one-piece ceramic light emitting diode substrate with a circular reflector cup in accordance with embodiments of the present invention. In this embodiment of the invention, the LED device 130 is located in a circular shaped reflector cup of the LED substrate 110c. The circular shaped reflector cup can be used to reflect light in a predetermined location. In one embodiment of the invention, the LED substrate 110c is made of ceramic and is a one-piece substrate and reflector cup.

FIG. 5D is an illustration of an exemplary one-piece ceramic light emitting diode substrate with a square reflector cup in accordance with embodiments of the present invention. In this embodiment of the invention, the LED device 130 is located in a square shaped reflector cup of the LED substrate 110d. The square shaped reflector cup can be used to reflect light in a predetermined location. In one embodiment of the invention, the LED substrate 110d is made of ceramic and is a one-piece substrate and reflector cup.

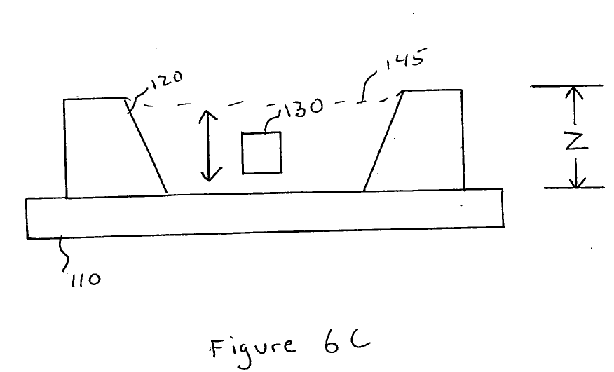

FIG. 6A is an illustration of an exemplary one-piece ceramic substrate and reflector cup with a LED at an adjustable height in accordance with embodiments of the present invention. By locating the LED 130 at various heights Z 610 (with respect to the top and bottom of the reflector cup of the substrate 110), the viewing angle of the device is modified. For example, locating the LED towards the bottom of the reflector cup narrows the viewing angle of the LED device, thus reducing light loss to the sides of the device. Correspondingly, positioning the LED device 130 towards the top of the reflector cup widens the viewing angle of the device, thus increasing light output to the sides of the device. In one embodiment of the invention, a desired viewing angle of the device can be achieved by locating the LED 130 at a location Z 610 between the top and the bottom of the reflector cup.

FIG. 6B is an illustration of an exemplary one-piece substrate and reflector cup with molded epoxy in a domed shape in accordance with embodiments of the present invention. In this embodiment of the invention, the molded epoxy 145 is in a domed shape. Because the reflector cup is located where the die 130 is located, an epoxy coating 145 can be easily deposited. In one embodiment of the invention, a transfer-molding process is used to deposit epoxy material 145 on substrate 110. In one embodiment of the invention, a dome shaped epoxy coating 145 increases the viewing angle of the LED device.

FIG. 6C is an illustration of an exemplary one-piece substrate and reflector cup with molded epoxy in a concave shape in accordance with embodiments of the present invention. In this embodiment of the invention, the molded epoxy 145 is in a concave shape. In one embodiment of the invention, a concave shaped epoxy coating 145 decreases the viewing angle of the LED device, thus reducing light leakage to the sides.

In summary, the ceramic LED package has excellent thermal properties and endurance to withstand heat from a high brightness LED device contrary to conventional plastic LED packages. The thermal properties of the ceramic package allow improvement in the brightness of LEDs without the requirement of making the package resistant to additional heat produced and without equipping the package with means for dissipating the heat quickly. The use of alumina and or aluminum nitride ceramic materials makes the ceramic LED package less susceptible to the degrading heat generated by high brightness LED devices. Such ceramic package also allows the use of high temperature during the assembly processes. In addition, the ceramic package retains more light and does not allow light leakage as do conventional resin based LED packages.

Ceramic LED packages can be made in smaller dimensions than conventional resin based LED packages and manufacturing techniques allow the sidewalls of the ceramic LED package to be formed substantially vertical, thus increasing the surface area of the ceramic cavity and allowing multiple LED devices to be mounted in a single ceramic LED package. The use of ceramic provides a more electrically efficient LED device that can be made smaller and at a lower cost.

Embodiments of the present invention, ceramic package for high brightness LED devices has been described. While the present invention has been described in particular embodiments, it should be appreciated that the present invention should not be construed as limited by such embodiments, but rather construed according to the following claims.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A light emitting diode package comprising:
a ceramic cavity comprising an integrated substrate for mounting a light emitting diode wherein said ceramic cavity and said integrated substrate can be manufactured simultaneously and wherein said cavity is shaped to focus light in a predetermined direction; and
a metallic coating on a portion of said ceramic substrate for reflecting light in a predetermined direction.

2. The light emitting diode as recited in claim 1 wherein said cavity is substantially a rectangular shaped cavity.

3. The light emitting diode as recited in claim 1 wherein said cavity is substantially a trapezoidal shaped cavity.

4. The light emitting diode as recited in claim 1 wherein said cavity is substantially an oval shaped cavity.

5. The light emitting diode as recited in claim 1 wherein said cavity is substantially a circular shaped cavity.

6. The light emitting diode as recited in claim 1 wherein said cavity is coated with a luminescent material.

7. The light emitting diode as recited in claim 6 wherein said luminescent material comprises phosphorus.

8. A method for manufacture of a light emitting diode package comprising:
forming a ceramic cavity having a bottom and a top and comprising an integrated substrate for mounting a light emitting diode wherein said cavity is shaped to focus light in a predetermined direction;
coating a portion of said ceramic cavity with a light reflective material;
positioning a light emitting diode on said substrate; and
depositing an optically transparent material in said cavity to protect said light emitting diode.

9. The method as recited in claim 8 wherein said forming said ceramic cavity comprises forming a cavity that is substantially rectangular shaped.

10. The method as recited in claim 8 wherein said forming said ceramic cavity comprises forming a cavity that is substantially trapezoidal shaped.

11. The method as recited in claim 8 wherein said forming said ceramic cavity comprises forming a cavity that is substantially oval shaped.

12. The method as recited in claim 8 wherein said forming said ceramic cavity comprises forming a cavity that is substantially circular shaped.

13. The method as recited in claim 8 further comprising coating said cavity with a luminescent material.

14. The method as recited in claim 13 wherein said luminescent material comprises phosphorus.

15. The method as recited in claim 8 wherein said positioning said light emitting diode comprises determining a location between said bottom and said top of said cavity to locate said light emitting diode to achieve a predetermined viewing angle of said light emitting diode.

16. The method as recited in claim 15 further comprising locating said light emitting diode closer to said bottom of said cavity to reduce said viewing angle of said light emitting diode.

17. The method as recited in claim 15 further comprising locating said light emitting diode closer to said top of said cavity to increase said viewing angle of said light emitting diode.

18. The method as recited in claim 8 wherein said depositing said optically transparent material in said cavity to protect said light emitting diode comprises forming a domed layer of said optically transparent material over said light emitting diode.

19. The method as recited in claim 8 wherein said depositing said optically transparent material in said cavity to protect said light emitting diode comprises forming a concaved layer of said optically transparent material over said light emitting diode.
